(19) United States
(12) Patent Application Publication
(10) Pub. No.: US 2026/0021387 A1
(43) Pub. Date: Jan. 22, 2026

(54) INPUT MECHANISM STRAIN SENSING AND MOTOR DRIVE

(71) Applicant: Meta Platforms Technologies, LLC, Menlo Park, CA (US)

(72) Inventors: Pavana Sirimamilla, Bothell, WA (US); Venkataraman Chandrasekaran, Chicago, IL (US); Cory Johnson, Renton, WA (US); Meriele Kwok, Seattle, WA (US); Timothy Ramsey, Seattle, WA (US)

(21) Appl. No.: 18/780,312

(22) Filed: Jul. 22, 2024

(51) Int. Cl. A63F 13/285; A63F 13/21; A63F 13/24; G01L 1/22; G01L 5/22

(52) U.S. Cl. CPC A63F 13/285; A63F 13/21; A63F 13/24; G01L 1/22; G01L 5/22

(57) ABSTRACT

A strain sensor is configured to measure a force applied by an input mechanism such as a trigger, button, or joystick. A motor is configured to be drive the input mechanism to particular positions in response to the strain measurement.

### TECHNICAL FIELD

This disclosure relates generally to controllers, and in particular to strain sensing in controllers.

### BACKGROUND INFORMATION

Tactile response to inputs provides feedback to a person providing the inputs. For example, turning on a conventional light switch may include the switch moving from one physical location to a second physical location, which provides mechanical feedback to a person that confirms the input was received. In the context of a controller for a video game console or a virtual reality (VR) headset, haptic feedback (e.g. vibrations or vibration patterns) may provide some feedback to users as to events occuring within the game or environment. Haptic actuators such as linear resonant actuators (LRA) may be used to drive the vibrations in a controller that is used in the gaming or VR context.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a system including an input mechanism, a strain sensor, processing logic, and a motor configured to drive the input mechanism to different positions, in accordance with aspects of the disclosure.

FIG. 2A illustrates a controller that includes example input mechanisms, in accordance with aspects of the disclosure.

FIG. 2B illustrates a virtual hand interacting with a virtual object, in accordance with aspects of the disclosure.

FIG. 2C illustrates a tactile profile of a virtual object, in accordance with aspects of the disclosure.

FIG. 3 illustrates an example architecture that includes a trigger, a cam mechanism, and a motor, in accordance with aspects of the disclosure.

FIG. 4 illustrates an example configuration of an example cam mechanism with respect to a strain sensor, in accordance with aspects of the disclosure.

FIG. 5 illustrates a plan view of a portion of an example flexible printed circuit that includes a plurality of electrical contacts, in accordance with aspects of the disclosure.

FIG. 6 illustrates a flow chart of an example process of motor push-back against force on an input mechanism, in accordance with aspects of the disclosure.

FIG. 7 illustrates a head-mounted display that may be communicatively coupled to a controller that includes a motor, a strain sensor, and an input mechanism, in accordance with aspects of the disclosure.

FIG. 8 illustrates an augmented reality (AR) headset that may be communicatively coupled to a controller that includes a motor, a strain sensor, and an input mechanism, in accordance with aspects of the disclosure.

### DETAILED DESCRIPTION

Embodiments of input mechanism strain sensing and motor drive are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Existing controllers for gaming or virtual reality (VR) contexts typically include haptic actuators to deliver vibrations to a hand of user holding the controller, in order to deliver some feedback to the person holding the controller. Different vibration patterns may be used to simulate different effects in the game or environment. However, simply delivering vibrations to a controller is insufficient to impart more realistic interactions for some contexts. By way of example, vibration patterns delivered to a controller do not impart the feeling of squeezing a tennis ball and feeling the elastic properties of the tennis ball. In existing controllers, a mechanical spring or elastic material may be used to return a trigger of a controller to a resting position of the trigger. However, the push-back or push-in of the trigger is dependent on the spring or elastic material that may have properties that decay or change over time. Additionally, the feedback experience of the user is dictated by the set response of the spring or elastic material. The set response may be non-linear, which may hinder the user experience or cause the user to experience the response as delayed. The fixed response of springs or elastic material is also not programmable for different contexts. For example, the feedback from compressing a baseball would be different than compressing a squishy water balloon.

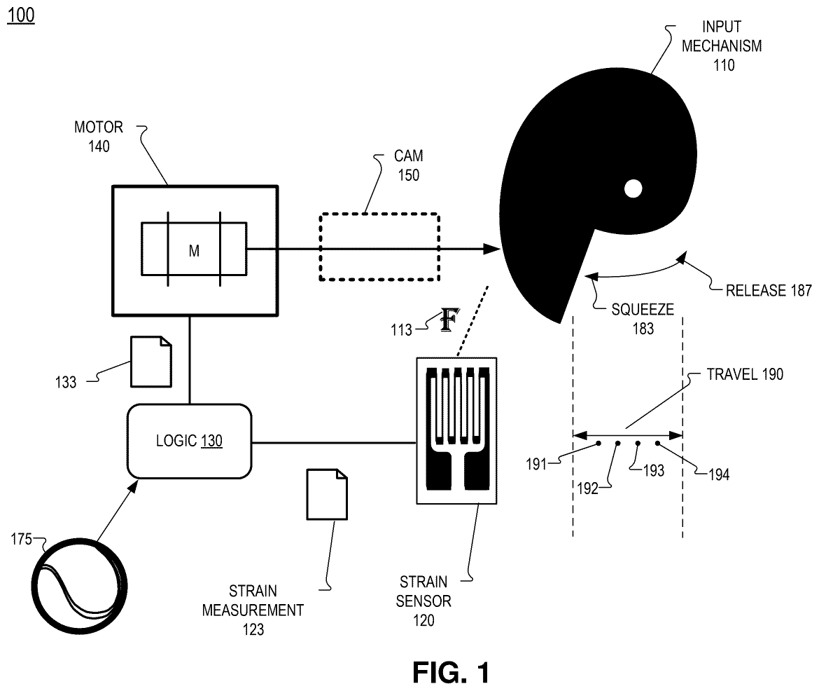

In implementations of the disclosure, a strain sensor measures the force applied by or to an input mechanism such as a trigger of a controller or a button of a controller. In response to the strain measurement, a motor configured to set a position of the input mechanism is driven to a motor-position. The motor-position may actually push-back against the force applied to the input mechanism by moving the input mechanism to different positions. The strain sensor may be included in the trigger or button, in some implementations. In some implementations, a tactile profile of a virtual object influences the driving of the motor. Hence, if a user is touching a virtual baseball in a virtual environment using a trigger of the controller, the motor may be driven to different positions than an interaction of a user holding a virtual water balloon. Of course, the user may interact with many different virtual objects that may have different tactile feedback that can be imparted to the user via a motor that drives the input mechanism according to force applied to the input mechanism. These and other implementations are described in more detail in connection with FIGS. 1-8.

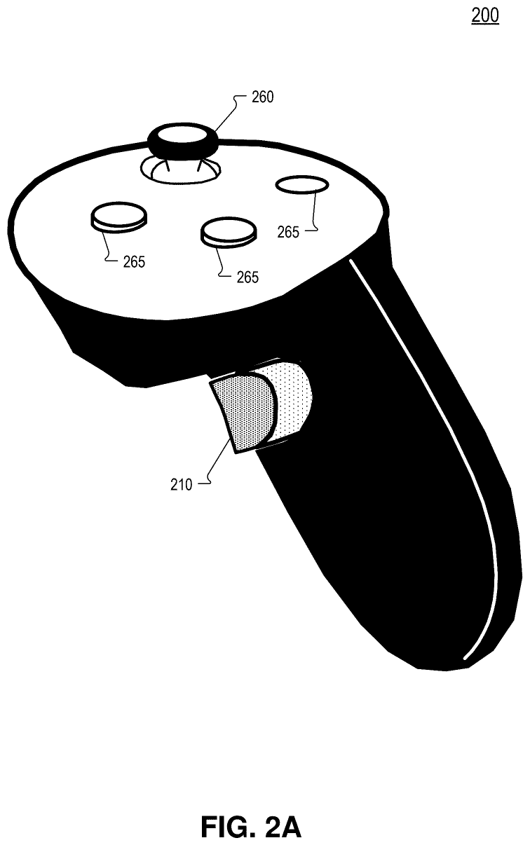

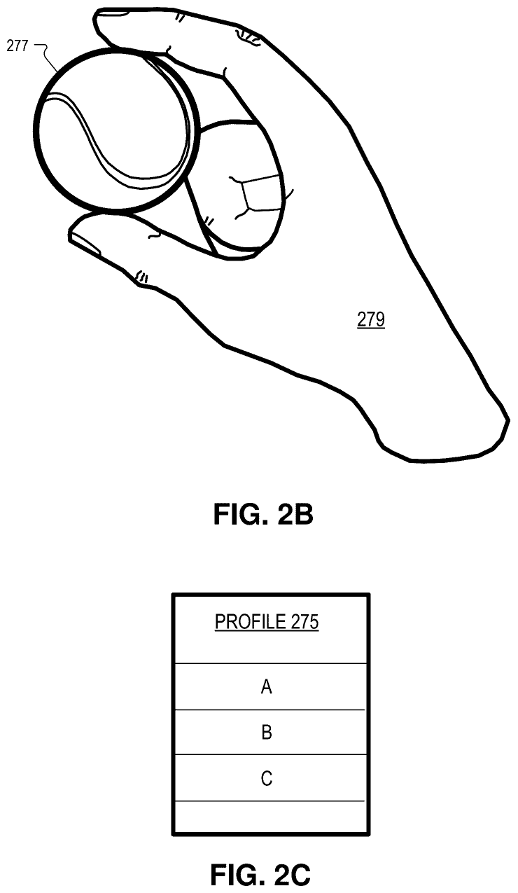

FIG. 1 illustrates a system 100 including an input mechanism 110, a strain sensor 120, processing logic 130, and a motor 140 configured to drive the input mechanism 110 to different positions, in accordance with aspects of the disclosure. In FIG. 1, input mechanism 110 is illustrated as a trigger of a controller such as the example trigger 210 of controller 200 in FIG. 2A. While a trigger may be illustrated and described as an example input mechanism in the disclosure, references to an “input mechanism” includes input interfaces such as a trigger 210, a button 265, a joystick 260, or any other input interface. The controller 200 of FIG. 2A may be considered a gaming controller or a controller for interacting with a virtual environment. Controller 200 may be communicatively coupled to a head-mounted display (HMD), in some aspects of the disclosure.

In FIG. 1, the illustrated trigger can be squeezed by a user to move the trigger in squeeze direction 183. The user may also release the trigger and the trigger will move in a release direction 187. Mechanical stops may mark the end of the squeeze direction 183 and the release direction 187 along a travel path 190 of the trigger. FIG. 1 illustrates that the trigger may have different travel positions 191, 192, 193, and 194 along travel path 190. As will be described in more detail, motor 140 may drive the trigger to different travel positions along travel path 190 that correspond to different motor-positions of motor 140 since motor 140 is configured to drive the input mechanism 110 to different travel positions along travel path 190. Motor 140 may drive input mechanism 110 to different travel positions via a cam mechanism 150, in some implementations. Motor 140 may be configured to push-back (move trigger in release 187 direction) or pull-in (move trigger in squeeze direction) in response to a force 113 applied by input mechanism 110, where the force 113 is measured by strain sensor 120. Driving motor 140 to a particular motor-position may move the trigger to oppose a squeezing force exerted on the trigger.

Strain sensor 120 may include a flexible printed circuit having multiple contacts and strain sensor 120 may output the strain measurement(s) 123 in response to an electrical resistance between the multiple contacts. In this example, the electrical resistance changes as a function of the force 113 being applied to the strain sensor 120. In an implementation, the strain sensor 120 is included in input mechanism 110 and the force 113 measured by the strain sensor 120 is the force applied by input mechanism 110 to cam mechanism 150. Cam mechanism 150 is disposed between motor 140 and input mechanism 110. Motor 140 may drive the travel position of input mechanism 110 via cam mechanism 150. Cam mechanism 150 may include a gear having teeth that are driven by motor 140. Cam mechanism 150 may be plastic, metal, or a combination of plastic and metal, for example.

Processing logic 130 is configured to receive one or more strain measurement(s) 123 and drive motor 140 to a motor-position in response to receiving the strain measurement(s) 123 from the strain sensor 120. Processing logic 130 may drive an analog or digital motor-position signal 133 onto motor 140 to drive motor 140 to a particular motor-position or sequence of motor-positions corresponding to travel positions of input mechanism 110.

In some implementations, processing logic 130 drives the motor 140 in response to (1) force 113 measured by strain sensor 120; and (2) a tactile profile 175 of a virtual object. The virtual object may be a tennis ball, baseball, water balloon, football, spring, vase, or otherwise.

FIG. 2B illustrates a virtual hand 279 interacting with virtual object 277, which is illustrated as a tennis ball in FIG. 2B. The virtual hand 279 may represent a position of a hand of a user. The hand of the user may be tracked by hand-tracking systems included in a HMD. The hand-tracking systems may include one or more cameras positioned to image hands of a user of the HMD when the user is wearing the HMD on their head. The index finger of the user and/or the thumb of the user may be squeezing or pushing on an input mechanism of a controller (e.g. controller 200). To simulate the interaction of the hand of the user with a virtual object, the motor 140 may be driven according to the force exerted on the input mechanism and attributes in a tactile profile of the virtual object.

FIG. 2C illustrates a tactile profile 275 of a virtual object that includes attributes A, B, and C of the virtual object. One of the attributes may be an elasticity factor of the virtual object. For example, a virtual tennis ball would have a higher elasticity factor than a virtual baseball does. One of the attributes may be a size of the virtual object. In some implementations, attributes of the tactile profile 275 may include a sequence of motor positions that correspond with travel positions of the input mechanism, where the travel positions are within a travel path (e.g. 190) of the input mechanism. The sequence of travel positions may impart a particular feeling to a user of the input mechanism that is touching the input mechanism. Of course, the tactile profile of the virtual object could include more or fewer attributes. Tactile profile 275 may be stored in memory included in processing logic 130. In an implementation, tactile profile 275 is stored in a memory that is not included in processing logic 130, but is accessible to processing logic 130.

In some implementations, a virtual effect (e.g. breaking a pot) may have a sequence of motor positions associated with it and processing logic 130 may drive the sequence of motor positions onto motor 140 in response to a force exerted on the input mechanism. For example, the sequence of motor positions that simulates breaking a pot may only be driven onto motor 140 when the user pushes an input mechanism hard enough so that the force measured by the strain sensor exceeds a threshold force required to break a virtual pot held in the hand 279 of the user.

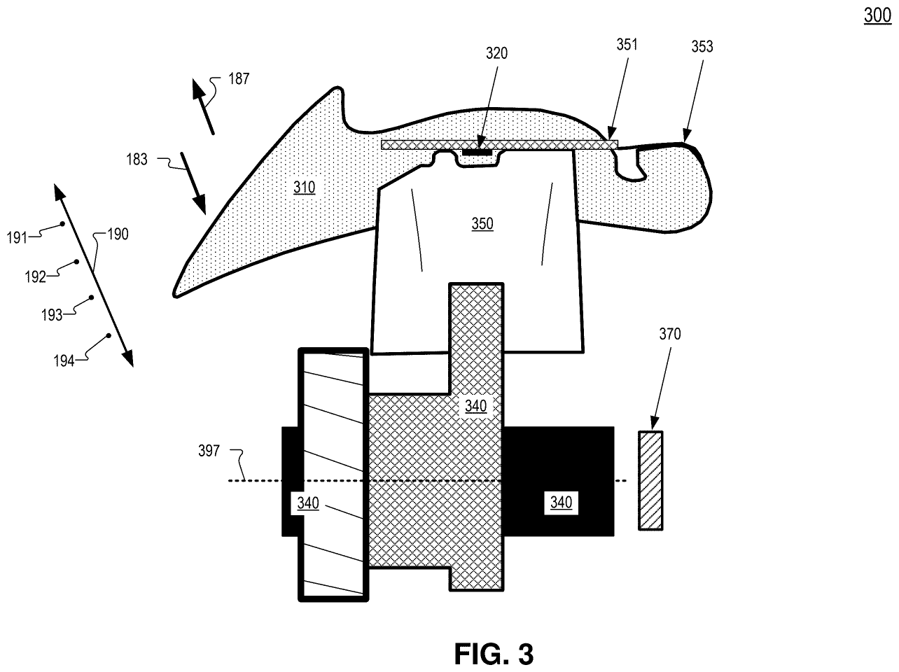

FIG. 3 illustrates an example architecture 300 of system 100, in accordance with aspects of the disclosure. Architecture 300 may be included in a controller, such as controller 200 of FIG. 2A. Architecture 300 includes a trigger 310 as an example input mechanism.

Trigger 310 includes a strain sensor 320 included in trigger 310. Strain sensor 320 may be coupled to a support 351 and be electrically coupled to other electrical components (e.g. processing logic 130) by way of a ribbon cable or flex circuit 353. Cam mechanism 350 is mechanically coupled between motor 340 and trigger 310. Motor 340 may be driven around an axis 397 in order to move cam mechanism 350 to move trigger 110 to different travel positions (e.g. positions 191, 192, 193, and/or 194) along travel path 190. In some implementations, motor 340 may include a gear that drives cam mechanism 350. In some implementations, motor 340 may include a screw that drives cam mechanism 350.

FIG. 3 illustrates that a motor position-sensor 370 may measure a position of motor 340. In some implementations, motor position-sensor 370 may be communicatively coupled to processing logic 130. Motor position-sensor 370 may be a Hall-Effect sensor that measures the position of motor 340. Motor 340 may include a magnet that rotates as the motor is driven in order to provide a measurable magnetic field to be measured by sensor 370 for sensing the position of motor 340.

Components 350, 340, and 370 may be hidden by a body of a controller while the left side of trigger 310 may be exposed to a user so that a trigger press by the user exerts a force in squeeze direction 183. When the user releases the trigger 310, the trigger 310 will move in release direction 187.

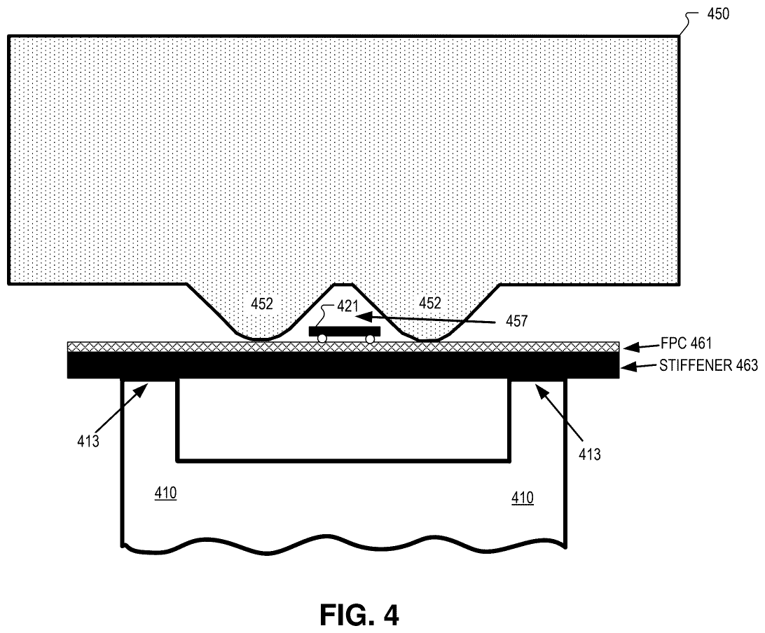

FIG. 4 illustrates an example configuration of cam mechanism 450 with respect to a strain sensor, in accordance with aspects of the disclosure. In FIG. 4, strain sensor chip 421, stiffener 463, and FPC are included in trigger 410. Trigger 410 is mechanically coupled to a stiffener 463. The stiffener 463 may be plastic or metal (e.g. steel). A flexible printed circuit (FPC) 461 is disposed over stiffener 463. FPC 461 may be adhered to stiffener 463. Strain sensor chip 421 is electrically coupled to electrical connections (e.g. pads) of the FPC 461. Strain sensor chip 421 is disposed in a void 457 of cam mechanism 450 that is between pressure extensions 452 that apply force to the strain sensor that includes strain sensor chip 421. Pressure extensions 452 are disposed between support pins 413 of trigger 410 to form a 4-point bend feature, in the illustration of FIG. 4. In other implementations, the support pins 413 may be included in another input mechanism (e.g. a button). The support pins 413 can be understood as supporting a “beam” that includes FPC 461 and stiffener 463. Support pins 413 may be “pinned” to stiffener 463 to secure the position of support pins 413 with respect to stiffener 463 and 461. Advantageously, positioning the pressure extensions 452 between support pins 413 forms a 4-point bend that may assist in providing more uniform strain readings by the strain sensor and increase the linearity of the sensor readings across different input forces with respect to displacement. The design of the illustrated cam mechanism 450 may also allow the force sensing range of the strain sensor to increase compared to prior designs. In an implementation, the force sensing range is up to 30 Newtons (N). In an implementation, the force sensing range is up to 40 Newtons (N). Previous ranges were limited to 20 Newtons or less.

Strain sensor chip 421 is configured to output the strain measurements in response to resistance measurements that measure electrical resistance between electrical contacts of FPC 461. After measuring the electrical resistance between the electrical contacts, strain sensor chip 421 may use a transfer function to estimate the force.

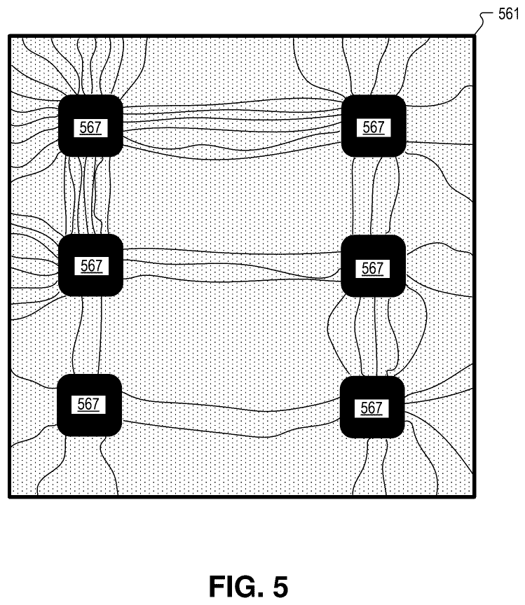

FIG. 5 illustrates a plan view of a portion of an example FBC 561 that includes a plurality of electrical contacts 567, in accordance with aspects of the disclosure. As force is applied around the different electrical contacts 567, the resistance between the electrical contacts changes. This resistance may be measured by strain sensor chip 421 disposed between pressure extensions 452. Pressure extensions 452 may apply force to the strain sensor as force from trigger 410 being squeezed presses FPC 461 into pressure extensions 452.

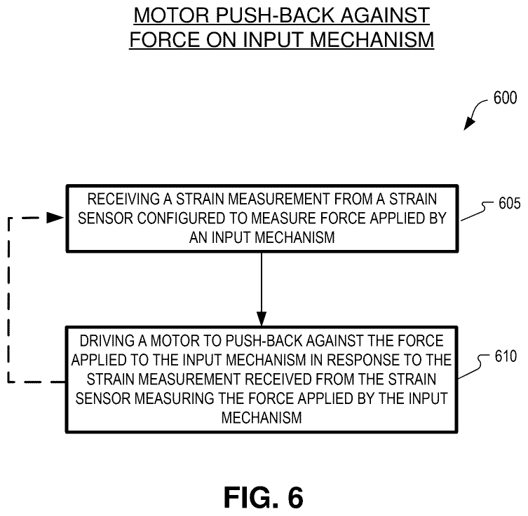

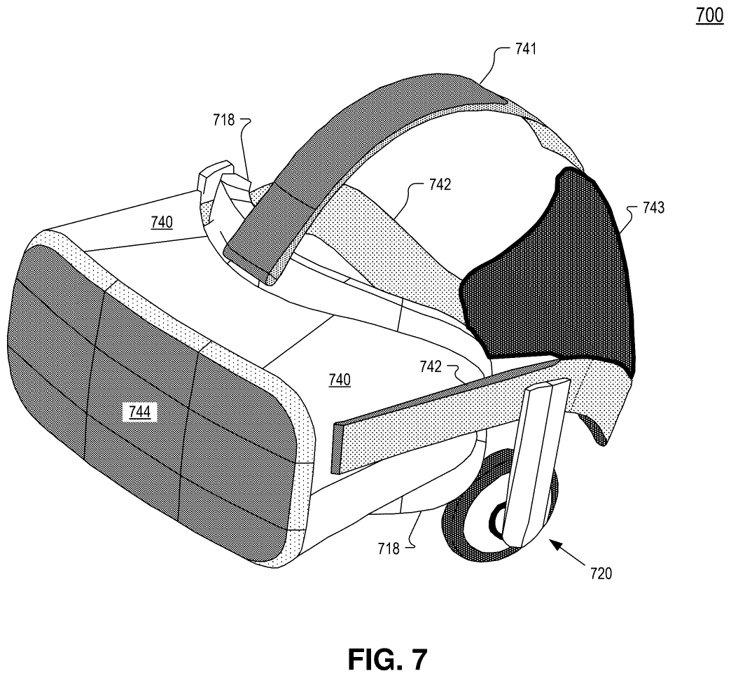

FIG. 6 illustrates a flow chart of an example process 600 of motor push-back against force on an input mechanism, in accordance with aspects of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel. In some implementations, processing logic (e.g. processing logic 130) executes all or a portion of process 600.

In process block 605, a strain measurement is received from a strain sensor. The strain sensor is configured to measure force applied by an input mechanism (e.g. a trigger or button).

In process block 610, a motor is driven to push-back against the force applied to the input mechanism in response to the strain measurement received from the strain sensor measuring the force applied by the input mechanism. In some implementations, process 600 returns to process block 605 after executing process block 610

In some implementations, a push-back value of the push-back against the force applied to the input mechanism is in response to a tactile profile of a virtual object. In an implementation, the push-back value corresponds to the elasticity factor in the tactile profile. In some implementations, the virtual object is for interacting with a virtual hand in a virtual environment.

In some implementations, the motor and the strain sensor are included in a controller configured to be held in a hand. The controller may be configured to be communicatively coupled to a head-mounted display that renders the virtual object.

In an implementation, driving the motor to push-back against the force applied to the input mechanism includes driving the motor to a sequence of motor positions that correspond with travel positions of the input mechanism. The travel positions are within a travel path of the input mechanism.

In an implementation, the sequence of motor-positions is progressively farther from a starting motor-position. In an example, the sequence of motor positions drives the input mechanism to travel position 191, then 192, then 193, then 194, in that order. Travel position 192 is between travel position 191 and 193. Travel position 193 is between travel position 192 and 194.

In an implementation, the sequence of motor-positions is progressively closer to a starting motor-position. In an example, the sequence of motor positions drives the input mechanism to travel position 194, then 193, then 192, then 191, in that order.

In an implementation, the sequence of motor-positions is not necessarily moving in the same direction for the entire sequence. In an example, the sequence of motor positions drives the input mechanism to travel position 193, then 194, then 191, then 192, in that order. In an example, the sequence of motor positions drives the input mechanism to travel position 192, then 191, then 194, then 193, in that order. In an example, the sequence of motor positions drives the input mechanism to travel position 194, then 191, then 193, then 192, in that order. In an example, the sequence of motor positions drives the input mechanism to travel position 191, then 194, then 192, then 193, in that order.

FIG. 7 illustrates a head-mounted display (HMD) 700 that may be communicatively coupled to a controller that includes a motor, a strain sensor, and an input mechanism, in accordance with aspects of the present disclosure. HMD 700 includes a display for presenting virtual images to an eye of a user of the HMD 700. HMD 700 may be considered a virtual reality (VR) headset or a mixed reality (MR) headset. The virtual images may include the virtual objects described in association with FIGS. 1-6.

HMD 700 is one type of head mounted device, typically worn on the head of a user to provide virtual reality content to a user. The illustrated example of HMD 700 is shown as including a viewing structure 740, a top securing structure 741, a side securing structure 742, a rear securing structure 743, and a front rigid body 744. In some examples, the HMD 700 is configured to be worn on a head of a user of the HMD 700, where the top securing structure 741, side securing structure 742, and/or rear securing structure 743 may include a fabric strap including elastic as well as one or more rigid structures (e.g., plastic) for securing the HMD 700 to the head of the user. HMD 700 may also optionally include one or more earpieces 720 for delivering audio to the ear(s) of the user of the HMD 700.

The illustrated example of HMD 700 also includes an interface membrane 718 for contacting a face of the user of the HMD 700, where the interface membrane 718 functions to block out at least some ambient light from reaching the eyes of the user of the HMD 700.

Example HMD 700 may also include a chassis for supporting hardware of the viewing structure 740 of HMD 700 (chassis and hardware not explicitly illustrated in FIG. 7). The hardware of viewing structure 740 may include any of processing logic, wired and/or wireless data interface for sending and receiving data, graphic processors, and one or more memories for storing data and computer-executable instructions. In one example, viewing structure 740 may be configured to receive wired power and/or may be configured to be powered by one or more batteries. In addition, viewing structure 740 may be configured to receive wired and/or wireless data including video data.

Viewing structure 740 may include a display system having one or more electronic displays for directing light to the eye(s) of a user of HMD 700. The display system may include one or more of an LCD, an organic light emitting diode (OLED) display, or micro-LED display for emitting light (e.g., content, images, video, etc.) to a user of HMD 700.

In implementations, the HMD 700 is configured to wirelessly communicate with a controller such as controller 200. HMD 700 may transmit a tactile profile of a virtual object to controller 200 so that processing logic 130 can access the tactile profile as an input for driving motor 140. Controller 200 may transmit strain measurements 123 to HMD 700 so that user interactions with virtual objects (e.g. squeezing a tennis ball) can be reflected in the presentation of the virtual images presented to an eyebox region by HMD 700.

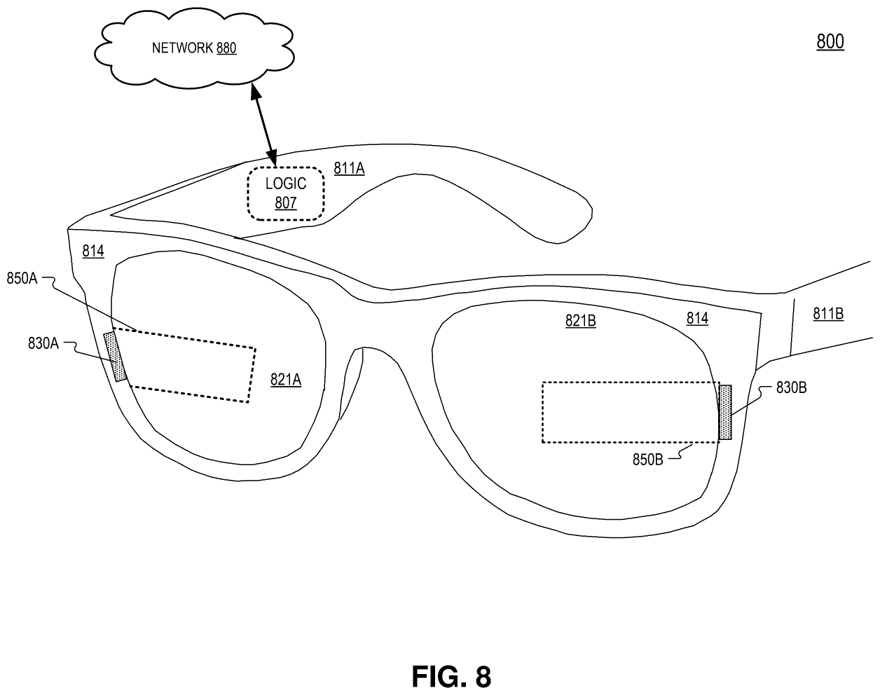

FIG. 8 illustrates an HMD 800 that may be communicatively coupled to a controller that includes a motor, a strain sensor, and an input mechanism, in accordance with aspects of the present disclosure. HMD 800 may be considered an Augmented Reality (AR) headset. The virtual images may include the virtual objects described in association with FIGS. 1-6.

HMD 800 includes frame 814 coupled to arms 811A and 811B. Lens assemblies 821A and 821B are mounted to frame 814. Lens assemblies 821A and 821B may include a prescription lens matched to a particular user of HMD 800. The illustrated HMD 800 is configured to be worn on or about a head of a wearer of HMD 800.

In the HMD 800 illustrated in FIG. 8, each lens assembly 821A/821B includes a waveguide 850A/850B to direct image light generated by displays 830A/830B to an eyebox area for viewing by a user of HMD 800. Displays 830A/830B may include a beam-scanning display or a liquid crystal on silicon (LCOS) display for directing image light to a wearer of HMD 800 to present virtual images, for example.

Lens assemblies 821A and 821B may appear transparent to a user to facilitate augmented reality or mixed reality to enable a user to view scene light from the environment around them while also receiving image light directed to their eye(s) by, for example, waveguides 850. Lens assemblies 821A and 821B may include two or more optical layers for different functionalities such as display, eye-tracking, and optical power. In some embodiments, image light from display 830A or 830B is only directed into one eye of the wearer of HMD 800. In an embodiment, both displays 830A and 830B are used to direct image light into waveguides 850A and 850B, respectively.

Frame 814 and arms 811 may include supporting hardware of HMD 800 such as processing logic 807, a wired and/or wireless data interface for sending and receiving data, graphic processors, and one or more memories for storing data and computer-executable instructions. Processing logic 807 may include circuitry, logic, instructions stored in a machine-readable storage medium, ASIC circuitry, FPGA circuitry, and/or one or more processors. In one embodiment, HMD 800 may be configured to receive wired power. In one embodiment, HMD 800 is configured to be powered by one or more batteries. In one embodiment, HMD 800 may be configured to receive wired data including video data via a wired communication channel. In one embodiment, HMD 800 is configured to receive wireless data including video data via a wireless communication channel. Processing logic 807 may be communicatively coupled to a network 880 to provide data to network 880 and/or access data within network 880. The communication channel between processing logic 807 and network 880 may be wired or wireless.

In implementations, the HMD 800 is configured to wirelessly communicate with a controller such as controller 200. HMD 800 may transmit a tactile profile of a virtual object to controller 200 so that processing logic 130 can access the tactile profile as an input for driving motor 140. Controller 200 may transmit strain measurements 123 to HMD 800 so that user interactions with virtual objects (e.g. squeezing a tennis ball) can be reflected in the presentation of the virtual images presented to an eyebox region by HMD 800.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 130) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A controller comprising:
an input mechanism;
a strain sensor configured to measure a force applied by the input mechanism;
a motor configured to set a travel position of the input mechanism;
processing logic configured to:
receive strain measurements from the strain sensor; and
drive the motor to a motor-position in response to receiving the strain measurements from the strain sensor.

2. The controller of claim 1, wherein the strain sensor includes:
a flexible printed circuit having multiple contacts, wherein the strain sensor outputs the strain measurements in response to an electrical resistance between the multiple contacts.

3. The controller of claim 2 further comprising:
a cam mechanism disposed between the motor and the input mechanism, wherein the motor drives the travel position of the input mechanism via the cam mechanism, and wherein the strain sensor is included in the input mechanism, and further wherein the force that is measured by the strain sensor is the force applied by the input mechanism to the cam mechanism.

4. The controller of claim 3, wherein the cam mechanism includes pressure extensions that apply the force to the strain sensor, and wherein a chip of the strain sensor is positioned in a void of the cam mechanism between the pressure extensions, and wherein the pressure extensions are disposed between support pins of the input mechanism to generate a linear force measurement with respect to displacement.

5. The controller of claim 4, wherein the strain sensor can measure the force when the force is greater than 20 Newtons.

6. The controller of claim 1, wherein the input mechanism includes a trigger or a button.

7. The controller of claim 6, wherein driving the motor to a particular motor-position moves the trigger or button to oppose a squeezing force exerted on the trigger or button.

8. The controller of claim 1, wherein the strain sensor includes:
a flexible printed circuit (FPC) including a plurality of electrical contacts; and
a chip electrically coupled to the plurality of the electrical contacts, wherein the chip is configured to output the strain measurements in response to resistance measurements that measure electrical resistance between the plurality of electrical contacts.

9. The controller of claim 1, wherein the motor-position that the motor is driven to is determined by a tactile profile of a virtual object.

10. A method comprising:
receiving a strain measurement from a strain sensor, wherein the strain sensor is configured to measure force applied by an input mechanism; and
driving a motor to push-back against the force applied to the input mechanism in response to the strain measurement received from the strain sensor measuring the force applied by the input mechanism.

11. The method of claim 10, wherein a push-back value of the push-back against the force applied to the input mechanism is in response to a tactile profile of a virtual object.

12. The method of claim 11, wherein the push-back value is in response to an elasticity factor of the tactile profile.

13. The method of claim 11, wherein the virtual object is for interacting with a virtual hand.

14. The method of claim 11, wherein the motor and the strain sensor are included in a controller configured to be held in a hand, and wherein the controller is configured to be communicatively coupled to a head-mounted display that renders the virtual object.

15. The method of claim 10, wherein the input mechanism includes a trigger.

16. The method of claim 10, wherein the input mechanism includes a button.

17. The method of claim 10, wherein driving the motor to push-back against the force applied to the input mechanism includes driving the motor to a sequence of motor-positions that correspond with travel positions of the input mechanism, the travel positions being within a travel path of the input mechanism.

18. The method of claim 17, wherein the sequence of motor-positions is progressively farther from a starting motor-position.

19. A device comprising:
an input mechanism;
a strain sensor configured to measure a force applied by the input mechanism; and
a motor configured to push-back against the force applied to the input mechanism based on strain measurement of the force measured by the strain sensor.

20. The device of claim 19, wherein the push-back against the force applied to the input mechanism is in response to a tactile profile of a virtual object.
